(19) United States
(12) Patent Application Publication
(10) Pub. No.: US 2025/0356444 A1
(43) Pub. Date: Nov. 20, 2025

(54) METHODS AND SYSTEMS FOR PREDICTING PARAMETERS RELATING TO COMMERCIAL REAL-ESTATE OCCUPANCY

(71) Applicant: CAPS FOR SALE ADABEC INC., Beaverton, OR (US)

(72) Inventors: Aaron SEGAL, Modiin (IL); Yossi BACHRACH, Haifa (IL); Idan HOROWITZ, Ra'anana (IL); Ari SEGAL, Modiin (IL)

(21) Appl. No.: 19/208,927

(22) Filed: May 15, 2025

Related U.S. Application Data
(60) Provisional application No. 63/647,890, filed on May 15, 2024.

(51) Int. Cl. G06Q 50/163

(52) U.S. Cl. CPC G06Q 50/163

(57) ABSTRACT

A computer implemented method for predictive modeling, which includes collecting data relating to properties leased to tenants, including features relating to the properties, the tenants, regional data, national data, or global data. Additional features are derived from the collected data, including additional features relating to the properties or the tenants. Each of the properties of the tenants is labeled to indicate a characteristic of the property or the tenant, where each labeled property or tenant is associated with property-features or tenant-features. A machine-learning based model is trained to predict a parameter a specific property or of a specific tenant, using a first subset of the labeled data. Following the training, and in response to receipt of an indication of a specific property or tenant, a prediction of the parameter for the property or the tenant is obtained from the machine-learning based model, and a report including the prediction is generated.

### RELATED APPLICATIONS

The present application gains priority from U.S. Provisional Patent Application No. 63/647,890 filed May 15, 2024 and entitled METHODS AND SYSTEMS FOR DETERMINING REAL-ESTATE OCCUPANCY, which is incorporated herein by reference as if fully set forth herein.

### FIELD AND BACKGROUND OF THE INVENTION

The invention, in some embodiments, relates to the field of real-estate occupancy, and more particularly to methods and systems for predicting whether a commercial property, used for a retail or wholesale establishment, will remain occupied for a future time period of a predetermined duration. The invention further relates to methods and systems for automatically selecting a suitable tenant for a vacated property, projecting the possible revenue from a commercial property, and/or analyzing parameters of a real-estate portfolio of a real-estate owner.

The main driver for the value of many real-estate properties, particularly in out-of-the-way locations, is the fact that they are rented out, for example to a store or other establishment. The same property, when vacated, would have a significantly lower value.

As a result, owners of such properties, as well as potential buyers of properties and entities that underwrite transactions with respect to such properties, want to know whether the property will remain occupied for a specific time horizon, e.g., 3, 5, 7, or 10 years ahead.

There are many factors contributing to the occupancy of the property-some being location related, others being tenant related, and yet others being on a national or global level. For example, a specific property being leased to a specific chain of stores, which has no competitors in the area, and/or the property having a high foot-traffic value or high conversion of foot-traffic into transactions, may contribute to the likelihood of the store remaining open for a longer duration. As another example, if the corporate office of a chain of stores appears to be diluting their number of stores in a specific state or region, that may an indicator that the likelihood of the store staying open long-term is reduced. National and Global aspects, such as recessions, pandemics, wars, and the like, may also contribute to the likelihood of a store remaining open long term.

Given the vast variety of features contributing to the likelihood of a store remaining open, it is very hard for owners or buyers of properties to predict what will happen with the property in the future. Some of the relevant information may be available from various sources, such as the physical properties of a store or the foot-traffic within the store, but integrating all the information is extremely difficult, and in fact is not done by most property owners. Usually, property owners determine whether to buy or sell a property that is leased to a store, or chain of stores, based on a “gut feeling” regarding what will happen in the next few years.

There is thus a need in the art for systems and methods for integrating the information contributing to the occupancy and rental amount of a commercial property, for predicting the likelihood of the property remaining occupied for a predetermined future time window, and for predicting the revenue projection from a property.

### SUMMARY OF THE INVENTION

Some embodiments of the invention relate to methods and systems for predicting occupancy of commercial properties during a future time period of a predetermined duration.

According to an aspect of the disclosed technology there is provided a computer implemented method for predictive modeling, the method including:
(a) collecting, from a plurality of sources, data relating to properties leased to tenants, the data including features relating to at least one of the properties, the tenants, a region in which the properties are located, national data, and global data;
(b) deriving, from the collected data, additional features relating to at least one of the properties and the tenants;
(c) for each of said properties, receiving a label indicating occupancy or vacancy of the property at one or more specific past times, to generate a collection including a plurality of labeled properties, each associated with a plurality of property-features;
(d) training a machine-learning based model to predict occupancy or vacancy of a specific property, by providing to the machine-learning based model a first subset of the collection, including a first subset of the plurality of labeled properties and their associated property-features;
(e) following said training, in response to receipt of an indication of a specific property, obtaining from the machine-learning based model a prediction including a probability that the specific property will remain occupied for one or more predetermined time horizons; and
(f) providing to a user a property report, the property report including at least the prediction made by the machine-learning based model.

In some embodiments, the method further includes, following (d) and prior to (e), testing accuracy of the machine-learning based model by providing to the machine-learning based model a second subset of the collection, including a second subset of the properties and their associated property-features, without providing the labels associated with the second subset of the properties to the machine-learning based model, and comparing predictions made by the machine-learning based model to the labels associated with the second subset of the properties.

In some embodiments, the method further includes, following (e) and prior to (f), ranking property-features associated with the specific property in accordance with their contribution to the prediction made by the machine-learning based model. In some embodiments, the property report includes at least a subset of the ranked property-features.

In some embodiments, the method further includes, following (e), automatically taking an action with respect to the specific property.

According to an aspect of the disclosed technology there is provided a computer implemented method for predictive modeling, the method including:
(a) collecting, from a plurality of sources, data relating to properties leased to tenants, the data including features relating to at least one of the properties, the tenants, a region in which the properties are located, national data, and global data;
(b) deriving, from the collected data, additional features relating to at least one of the properties and the tenants;
(c) for each of the properties of the tenants, receiving a label indicating a characteristic of the property or the tenant, to generate a collection including a plurality of labeled properties or tenants, each associated with a plurality of property-features or tenant-features;
(d) training a machine-learning based model to predict a parameter a specific property or of a specific tenant, by providing to the machine-learning based model a first subset of the collection, including a first subset of the plurality of labeled properties and their associated property-features and/or a first subset of the plurality of labeled tenants and their associated tenant features;
(e) following the training, in response to receipt of an indication of a specific property or tenant, obtaining from the machine-learning based model a prediction of the parameter for the property or the tenant; and
(f) generating a report including at least the prediction made by the machine-learning based model.

In some embodiments, at step (c), the receiving of the label includes receiving a label indicating occupancy or vacancy of the property at one or more specific past times, and the collection includes a collection of labeled properties, each associated with a plurality of property-features. In some embodiments, at step (d), the training includes training the machine-learning based model to predict occupancy or vacancy of a specific property. In some embodiments, at step (e), the obtaining includes, obtaining from the machine-learning based model a prediction including a probability that the specific property will remain occupied for one or more predetermined time horizons.

In some embodiments, at step (c), the receiving of the label includes receiving a label indicating, for a specific potential tenant, a quality of properties rented by the specific potential tenant or a rental amount paid by the specific potential tenant for another property. In some embodiments, at step (d), the training includes training the machine-learning based model to predict a likelihood that the specific potential tenant would want to occupy a specific property. In some embodiments, at step (e), the obtaining includes, obtaining from the machine-learning based model a prediction including a probability that the specific potential tenant would occupy the specific property.

In some embodiments, at step (c), the receiving of the label includes receiving a label indicating a rental amount paid for the property currently or at one or more specific past times, and the collection includes a collection of labeled properties, each associated with a plurality of property-features. In some embodiments, at step (d), the training includes training the machine-learning based model to predict a distribution of a rental amounts expected to be paid for a specific property. In some embodiments, at step (e), the obtaining includes, obtaining from the machine-learning based model a prediction including a probability distribution of a rental amount that will be paid for the specific property at one or more predetermined future timestamps.

In some embodiments, the computer implemented method further includes, following (d) and prior to (e), testing accuracy of the machine-learning based model by providing to the machine-learning based model a second subset of the collection, including a second subset of the properties and their associated property-features, without providing the labels associated with the second subset of the properties to the machine-learning based model, and comparing predictions made by the machine-learning based model to the labels associated with the second subset of the properties.

In some embodiments, the computer implemented method further includes, following (e) and prior to (f), ranking features in accordance with their contribution to the prediction made by the machine-learning based model.

In some embodiments, the providing of the report includes providing a report including at least a subset of the ranked features.

In some embodiments, the computer implemented method further includes, following (e), automatically taking an action with respect to the specific property or tenant.

In some embodiments, there is provided a computer implemented method of assessing a risk of a property portfolio of a property owner, the property portfolio including a plurality of properties, the method including:
(a) for each property of the plurality of properties, carrying out the method described herein to predict at least one parameter relating to the property; and
(b) providing to the property owner a portfolio report, based on the report generated for each property, the portfolio report indicating at least one of:
   a risk factor expected to impact a subset of the plurality of properties greater than a threshold subset size;
   a percentage or number of the plurality of properties at risk by a specific risk factor;
   a percentage or sum of revenue eat risk by the specific risk factor;
   one or more suggestions for diversification of the portfolio; and
   one or more suggestions for redevelopment or subdivision of one or more of the plurality of properties.

In some embodiments, step (a) includes, for each property of the plurality of properties, predicting a probability that the property will remain occupied for one or more predetermined time zones.

In some embodiments, step (a) includes, for each property of the plurality of properties, predicting a distribution probability of rental income that can be obtained from the property currently or at one or more predetermined future time stamps.

In some embodiments, step (a) includes, for each property of the plurality of properties, predicting whether redevelopment or subdivision of the property would increase the revenue gained from the property, currently or at one or more predetermined future time stamps.

In some embodiments, step (a) includes, for each property of the plurality of properties, proposing one or more potential tenants predicted to have an interest in renting the property, currently or at one or more predetermined future time stamps.

In some embodiments, the computer implemented method further includes repeating steps (a) and (b) periodically.

Unless otherwise defined, all technical and scientific terms used herein have the same meaning as commonly understood by one of ordinary skill in the art to which the invention pertains. In case of conflict, the specification, including definitions, will take precedence.

As used herein, the term “property” relates to a physical property, such as a building or structure, used for commercial, or retail, purposes.

As used herein, the term “trade area” relates to an area about a given property from which a specified percentage of the foot traffic to that property originates. The trade area may be mapped out as having any shape, whether symmetrical or not, and is confined by, or restricted to, a certain radius about the property. For example, a property may have a trade area having a polygonal shape around the property, the polygonal shape contained within a radius of 10 miles around the property, if 90% of the foot traffic of the property comes from within that polygonal shape. As a broader example, a property may have a trade area having a shape contained within a circle having a radius of Y miles, if X % of the foot traffic of the property comes from within that shape.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

As used herein, “substantially” and “substantially shown,” are defined as “at least 90%,” or as otherwise indicated.

As used herein, “and/or” is defined inclusively such that the term “a and/or b” should be read to include the sets: “a and b,” “a or b,” “a,” “b.”

As used herein, “at least one of A and B” is defined as “at least one of A” or “at least one of B” or “at least one of A and at least one of B”.

Embodiments of methods and/or devices of the invention may involve performing or completing selected tasks manually, automatically, or a combination thereof. Some embodiments of the invention are implemented with the use of components that comprise hardware, software, firmware or combinations thereof. In some embodiments, some components are general-purpose components such as general-purpose computers or oscilloscopes. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a schematic block diagram of an embodiment of a system used for predicting parameters of a commercial property and its occupancy according to an embodiment of the teachings herein;

FIG. 2 is a flow chart of an embodiment of a method of predicting occupancy of a property leased to a tenant in accordance with an embodiment of the teachings herein;

FIG. 3 is a flow chart of an embodiment of a method of predicting suitable re-tenanting options for a property in accordance with an embodiment of the teachings herein;

FIG. 4 is a high-level block diagram of devices useful for carrying out embodiments of the disclosed technology.

### DESCRIPTION OF SOME EMBODIMENTS OF THE INVENTION

The invention, in some embodiments, relates to the field of real-estate occupancy, and more particularly to methods and systems for predicting various parameters relating to a commercial property and its occupancy, such as whether the property will remain occupied for a future time period of a predetermined duration.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

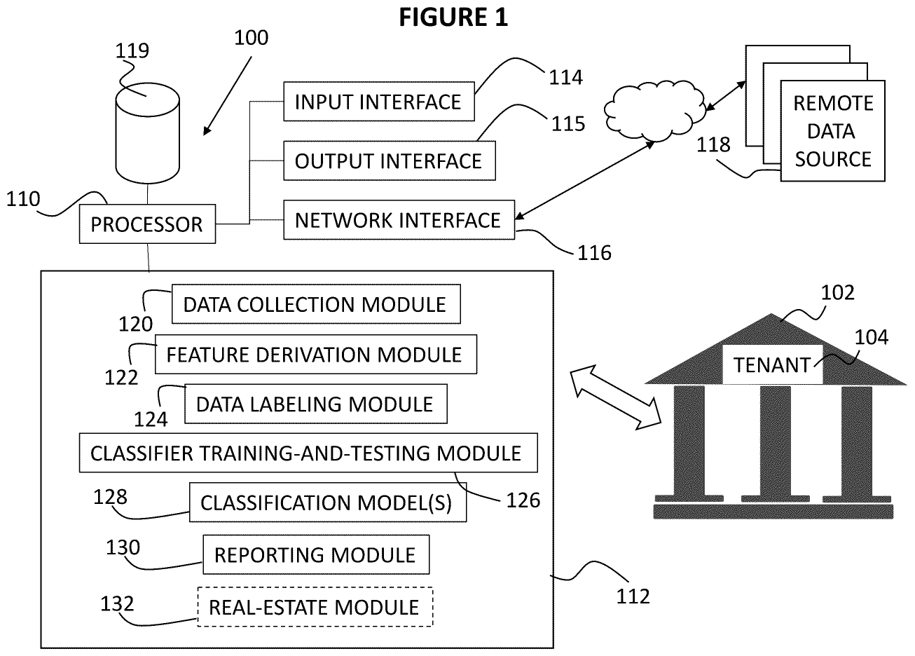

Reference is now made to FIG. 1, which is a schematic block diagram of an embodiment of a system 100 used for predicting parameters of a commercial property 102, currently leased to a tenant 104, according to an embodiment of the teachings herein. For example, and as explained in further detail hereinbelow, the parameters can include parameters relating to the occupancy of the property, such as a prediction of occupancy of the property within a specific future-horizon, parameters relating to suitable tenants, and parameters relating to optimizing monetization of the property, for example a type of tenant that would be most suitable, or a breakup of the property that would improve its monetization.

The system of the disclosed technology is particularly useful for predicting parameters relating to a property used for commercial purposes, such as a property leased to a retailer or a wholesaler.

As seen in FIG. 1, system 100 includes at least one processor 110 and at least one storage medium 112 storing computational modules, or instructions, to be executed by processor 110. Processor 110 is functionally associated with at least one input interface 114 adapted to receive input from a human user, such as a keyboard, a mouse, or a touchpad, and/or with at least one output interface 115 for providing output to a user, such as a screen or speaker. Processor 110 is further associated with a network interface 116, such as a transceiver, adapted to receive input from a plurality of sources 118 external to system 100, for example via a network connection therewith (e.g., via the Cloud or the Internet). In some embodiments, the system further includes at least one database 119, storing data relating to properties and/or to tenants, which database is functionally associated with processor 110.

Storage medium 112 may store a plurality of software modules, each of which may be associated with one or more instructions, to be executed by processor(s) 110, to achieve a specified result.

Storage medium 112 has stored a data collection module 120, configured for collection of data from multiple sources, the data relating to properties and to tenants. Data collection module may store the collected data in database 119.

In some embodiments, the collected data pertains to property 102 and to tenant 104, including data pertaining to other properties leased to tenant 104. In some embodiments, the collected data relates to one or more properties leased to other tenants. For example, data collection module 120 may be configured for collection of data relating to all properties leased to major retain brands, or tenants, for example brands that are widely traded in the commercial real-estate market. In some embodiments, data collection module 120 may collect data pertaining to regional brands, or tenants, for example brands or tenants that are common in a specific state, province, or district. In some embodiments, data collection module 120 may, additionally or alternatively, collect data pertaining to national brands, or tenants, for example brands or tenants that are common throughout a country.

In some embodiments, data collection module 120 may collect current data, relating to various features of the property or properties, at the time of data collection. In some embodiments, data collection module 120 may further collect historical data, relating to various features of the property or properties, over a previous duration of predetermined length. For example, the data may relate to the last 3 years, the last 5 years, the last 7 years, or the last 10 years.

In some embodiments, data collection module 120 may further collect data relating to a specific tenant or potential tenant, such as data relating to a specific vendor that is currently, or can be in the future, a tenant of a store, their renting/vacating habits, the locations of that vendor's stores, and parameters relating to stores of a specific vendor.

In some embodiments, data collection module 120 may be configured to periodically or intermittently update the collected data, and store the updated data in database 119. For example, on the first day of each calendar month, the data collection module may collect data relating to the past month.

Data collection module 120 may be configured to collect data relating to a wide range of features, including, for example, any one or more of the following:
Occupancy data—data relating to whether or not a property is occupied;
Physical data—data relating to physical aspects of a property (e.g. square footage, accessibility to disabled people, and the like)
Foot-traffic data—data relating to the foot-traffic in the property (e.g. how many people per day, average number of people per square foot in a predetermined duration, and the like);
Sales data—data relating to the number of and revenue from sales in the property (e.g. how many items were sold, average transaction size, number of transactions per month income, percentage of transaction follow-through, and the like);
Demographic data—data relating to demographic aspects of the patrons of a property and/or the population in the trade area (e.g., ethnicity, socio-economic level, and/or education level in that geographic region, and the like);
Geographic data—data relating to the location of the property (e.g., latitude, U.S. State, and the like);
Economic data—data relating to economical features in the region of the property as well as on a national level (e.g. GDP, GNP, recession features, and the like); and
Real-estate data—data relating to real-estate in a given area or to a given property (e.g., historical data of leases of the property and neighboring properties, lease terms, sales of the property and neighboring properties, and the like).

Storage medium 112 may further have stored a feature derivation module 122, configured to derive additional features relating to the properties and/or tenants for which features were collected by data collection module 120. Feature derivation module 122 uses the data collected by data collection module 120, to derive additional features relating to the properties or tenants. The derived features may be straightforward, or may be more complex. Often, derived features include ratios between two collected features, or between collected features and other derived features. The derived features may be stored in database 119.

In some embodiments, feature derivation module 122 may use images of properties, or information relating to exact boundaries of a trade-area of a property, for derivation of features. In some embodiments, feature derivation module 122 may use machine learning techniques, such as convolutional neural networks or short-term memory networks to derive the additional features. In some embodiments, feature derivation module 122 may additionally use temporal data and patterns, weather data and patterns, and/or financial data and patterns to derive the additional features.

In some embodiments, feature derivation module 122 may be configured to periodically or intermittently update the derived data, and store the updated data in database 119. For example, the feature derivation module 122 may update the derived data following updates to the collected data by data collection module 120.

A few examples of derived features include:
A ratio between the total foot traffic to a given property during July-December of the previous year, and the total foot traffic to the same property during January-June of the previous year;
A number of neighbors within a predetermined distance: a property X is considered to be a “neighbor” of property Y if X and Y belong to the same retailer, or chain of stores (e.g., both are CVS stores)—this feature counts the number of neighbors of a store Y, within a predetermined distance, or radius, e.g. 5 miles;
A main neighbor of a property: X is considered to be the “main neighbor” of property Y if X and Y are “neighbors”, and the trade area overlap between X and Y is greater than the trade area overlap of Y with any other neighbor of Y (trade area overlap is the overlap in the geographical area from which patrons come to the store, or property);
A number of competitors within a predetermined distance: a property X is considered to be a “competitor” of property Y if X and Y belong to the same industry, but to different retailers, or chains of stores (e.g., both are pharmacies, but Y is a CVS and X is a Walgreens)—this feature counts the number of competitors of a store Y, within a predetermined distance, or radius, e.g. 5 miles;
A main competitor of a property: X is considered to be the “main competitor” of property Y if X and Y are “competitors”, and the trade area overlap between X and Y is greater than the trade area overlap of Y with any other neighbor of Y (trade area overlap is the overlap in the geographical area from which patrons come to the store, or property);
Foot-traffic to square-foot: for a given property, this is the ratio between the foot traffic, in a given time period, to the square footage of the property; and
Main neighbor foot-to-square-foot ratio—this is a ratio of the foot-to-square-foot value of a given property, to a foot-to-square-foot of the property's main neighbor.

Storage medium 112 may further have stored a data labeling module 124, configured to receive a label to be applied to each property, for one or more timestamps.

In some embodiments, the label may indicate whether the property was leased (e.g. the store remained open, or was closed and re-leased) or occupied at that timestamp. In some embodiments, the labeling is binary, into two categories-“occupied” and “vacant”, or “open” and “closed”. For example, a given property may be labeled as “occupied” or “vacant” on January 1, of each year of a predetermined period, e.g. between 2015 and the current date.

In some embodiments, data labeling module 124 may further label the occupancy or vacancy of properties over a time window of a specific length. For example, has the property been occupied consistently in the past 3 years, in the past 5 years, or in the past 7 years. Such labeling may be directly obtained from the user via user interface 114, or may be derived from information provided by the user. For example, if the user labels the property as being vacant or occupied on January 1 of each year, the data labeling module may derive the occupancy of the property for each prior time window.

In some other embodiments, the label may indicate a lease amount and/or a lease term for a property, for example with respect to a specific tenant or for a specific time frame.

In some embodiments, the labels applied by data labeling module 124 may be stored in database 119, for example as additional features for each of the classified properties.

Storage medium 112 further has stored a classifier training-and-testing module 126, configured to use data collected by data collection module 120 and/or derived by feature derivation module 122, together with labeled data from module 124, to train one or more machine-learning based classification models 128. Models 128 typically uses existing machine-learning algorithms to learn the collected and derived features, and a degree to which they are relevant for making predictions for unseen data, such as to make a prediction regarding the probability of a property to be vacated in the future. For example, classifier training-and-testing module 126 may train model 128 to use xgboost algorithm, random forest algorithms, neural networks, and the like.

In some embodiments, once trained, one or more model 128 is an occupancy predicting model, configured to predict the probability of a property being vacant or occupied, at a specific future timestamp or for a predetermined future time window (e.g. for the next 3 or 5 years).

In some embodiments, once trained, one or more model 128 is a re-tenanting model, configured to predict a suitable tenant, or configuration, for re-tenanting a property in the future, if/when the property is vacated.

In some embodiments, once trained, one or more model 128 is a revenue projecting model, configured to predict the fair market value of a property for a specific type of tenant, and/or to predict a mechanism for maximizing the revenue possible from the property, at a specific (present or future) timestamp.

In some embodiments, once trained, one or more model 128 is a portfolio analysis model, configured to analyze the property portfolio of a property owner, and in particular to predict risk factors that may have a strong impact on the property portfolio at a specific (current or future) timestamp.

Typically, classifier training module 126 uses collected and derived data relating to a first portion of the properties that have been labeled by module 124, and/or collected and derived data relating to a first portion of tenants, to train model(s) 128. The second portion of the properties (and/or tenants) for which labels (ground truth) are known, but which have not been seen by the model, are used to test the quality of the model. For example, when training a model 128 to predict the occupancy or vacancy of properties, the testing step may including asking the model to predict the occupancy or vacancy of properties in that second portion of properties and ascertaining whether the predictions are correct or not.

In some embodiments, model(s) 128 may be brand-specific, such that it takes into consideration the management decisions of that brand. In such cases, the model(s) may be able to predict whether property 102, currently occupied by that brand as tenant 104, would remain occupied, but may have a hard time predicting whether another brand would occupy property 102.

In some embodiments, model(s) 128 may be industry-specific (e.g., may relate to pharmacies or dollar stores), such that it takes into consideration a broader set of features relating to the specific industry. In some embodiments, the industry-specific model(s) may be supplemented with brand-specific information.

In some embodiments, model 128 may be trained to predict occupancy or vacancy with respect to a specific time horizon—e.g. 1 year ahead, 3 years ahead, 5 years ahead, etc. In some embodiments, a single model may be trained for multiple different time horizons, whereas in other embodiments each time horizon may be associated with a specific model 128.

Each model 128 is stored in storage medium 112.

When a model 128 is trained to predict occupancy or vacancy of a property, it is configured to receive recent data and to provide a prediction for the likelihood of property 102 being vacant or occupied based on recent data, also termed predictor data, collected and/or derived by modules 120 and 122 following training of the model, without the data being previously labeled. For example, model 128 may provide a prediction including a likelihood, or weight, that property 102 will be leased to tenant 104 for one or more future time windows.

In some embodiments, model 128 may provide predictions including a likelihood of occupancy for all properties currently occupied by tenant 104.

In some embodiments, model 128, or an additional software module running in parallel to, or after, model 128, provides a list of all the features known to the model, e.g. features collected by module 120 or derived by module 122, ranked according to their importance in determining the occupancy of a property for a time horizon. In some embodiments, the ranking may be model-based—i.e., may be common to all predictions made by the model, whether for a specific brand or for a specific industry. In other embodiments, the ranking may be property-based—i.e., may be a unique ranking showing the effect of the features on the classification of each specific property for a given time horizon. In some embodiments, existing algorithms, such as SHAPs, may be used to provide this feature ranking.

When a model 128 is trained to assess re-tenanting of a property 102, it is configured to receive current data, for example relating to current foot-traffic in the property, and to identify one or more potential tenants that would be suitable for occupying the property while maximizing the revenue gained from the property. In some embodiments, this model 128 may also be configured to receive current data relating to the potential tenant and their existing venues.

The model may then generate, based on the training thereof, a prediction of which potential tenant or tenants would be suitable for taking over property 102, should it become vacated. In some embodiments, the model may automatically estimate the likelihood of a potential tenant becoming a tenant of property 102, while automatically taking into consideration the level of “cannibalization” that specific potential tenant is likely to allow. In this context, the term “cannibalization” relates to the expected decrease in foot traffic and sales, at other properties operated by the same potential tenant, if that potential tenant were to occupy property 102. For example, distance to other properties operated by the potential tenant may be taken into account when considering cannibalization likelihood.

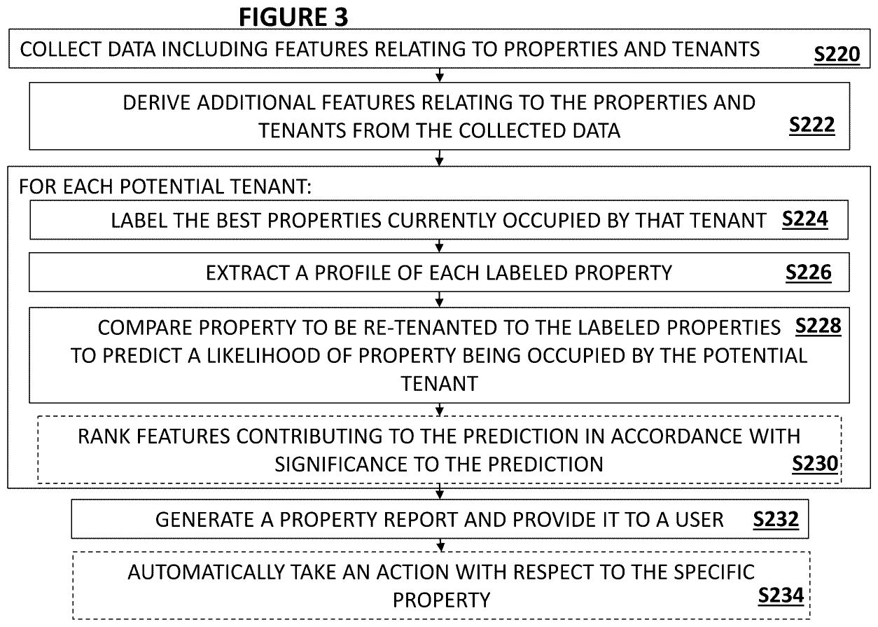

As explained in further detail hereinbelow with respect to FIG. 3, when considering which potential tenants would be suitable to occupy property 102, the model 128 takes into consideration all the collected and derived features relating to the potential tenant, to the property, and to other properties occupied by the potential tenant, and attempts to compute how much that potential tenant would want to occupy property 102. The computation is more complex than using just a single metric, such as foot traffic or distance to other properties occupied by the tenant, and takes into consideration aspects and strategies that the model has learned about the behavior of the tenant with respect to their occupied properties.

A revenue projecting model 128 predicts the expected revenue, from a property, for a specified time window. The revenue projecting model may propose a specific industry that would enable the owner to charge a higher rent. The revenue projecting model may recommend dividing the space of property 102 into several smaller spaces and renting those out separately, where each portion may be rented out to a different potential tenant to be identified by the re-tenanting model. The revenue projecting model could also recommend redeveloping of the property to increase the revenue gained from the property.

A portfolio analysis model 128 periodically or intermittently analyzes the property portfolio of a property owner, to assess common risk factors built into the portfolio. For example, the portfolio analysis model 128 may identify that a certain percentage of the properties in the portfolio would be affected in a similar (positive or negative) manner if certain events were to occur. The portfolio analysis model 128 may propose or suggest methods of diversifying the portfolio in order to increase revenue and/or to reduce risk in the portfolio.

In some embodiments, one model 128 may use the computation, or output, of another model 128, as part of its computation process.

For example, the re-tenanting model may use information from the occupancy prediction model to estimate when re-tenanting would be required, or may use information from the revenue projecting model to identify suitable industries from which potential tenants for the property may be evaluated.

As another example, the revenue projecting model may use the occupancy prediction of an occupancy prediction model to provide a projection of the total revenue expected from a property for a certain future timeframe (e.g., if the property is expected to be occupied for the next five years the revenue projection will be different than if the same property is expected to be vacated for some of that time).

As a further example, the portfolio analysis model may use occupancy predictions of an occupancy prediction model for each of the properties in the portfolio, to assess risk for a certain future time frame (e.g., if a large portion of the properties in the portfolio are expected to be vacated in three years time). The portfolio analysis model may further use the revenue projecting model for each property in the portfolio, to assess an expected revenue of the whole portfolio.

Storage medium 112 further has stored a reporting module 130, configured to generate a report based on the predictions made by model 128, and to provide the report to the user, for example via output interface 115 or as an email or other electronic message sent to the user via network interface 116.

In some embodiments, reporting module 130 is configured to receive a request for a report on a specific property, e.g. property 102, for example via user interface 114. In response to the request, the reporting module 130 is configured to generate a property report for the specified property.

For example, the report may include the likelihood that the property will remain occupied for one or more time horizons. As another example, the report may include a list of one or more potential tenants that may want to occupy the property if/when it is vacated. As yet another example, the report may provide an assessment of the revenue that can be earned from the property, and provide suggestions as to a mechanism for maximizing the revenue.

In some embodiments, the property report may include a chart or other data structure to support the reported information. For example, a chart may show the likelihood of the property remaining occupied over multiple time horizons.

In some embodiments, such as embodiments in which the model is an occupancy predicting model, the property report may include a list of features relating to the property and information relating to those features. For example, for each listed feature, the information may include the value of the property for that feature, a comparative value of another property for that feature, a ranking of whether the feature contributes to a positive or negative outcome in the long-run (e.g. when the feature increases the likelihood of the property remaining occupied that is considered contribution to a positive outcome), and/or a ranking of the significance of the feature in reaching the provided prediction (e.g., how significant was this feature in predicting the occupancy or vacancy of the property in the specified time horizon). In some embodiments, the list may relate to a predetermined number of features that had the greatest impact on the prediction made by the model, for example based on the ranking explained above.

In some embodiments, such as embodiments in which the model is an occupancy predicting model, the property report may further include a comparison to another property, such as a comparison to the main neighbor, main competitor, or to an average property of the same brand.

In some embodiments, such as embodiments in which the model is a re-tenanting model, the property report may include a list of tenants suitable for re-tenanting of the property, a list of features relating to those tenants and information relating to those features, and/or a list of features relating to the property and information relating to those features. For example, for each listed tenant-feature, the information may include a comparative value of another potential tenant for that feature, a ranking of whether the feature contributes to a positive or negative outcome with a specific tenant in the long-run, and/or a ranking of the significance of the feature in reaching the provided prediction (e.g., how significant was this feature in predicting that a certain tenant would be a good potential tenant for occupying the property if/when it is vacated). In some embodiments, the list may relate to a predetermined number of features that had the greatest impact on the prediction made by the model, for example based on the ranking explained above.

In some embodiments, such as embodiments in which the model is a revenue projecting model, the property report may include a list of features relating to the property and information relating to those features. For example, for each listed feature, the information may include the value of the property for that feature, a comparative value for that feature if a characteristic of the property was changed (e.g., subdividing or leasing to a different tenant), a ranking of whether the feature contributes to a positive or negative outcome in the long-run (e.g. when the feature increases the likelihood of the property providing a higher revenue that is considered contribution to a positive outcome), and/or a ranking of the significance of the feature in reaching the provided prediction (e.g., how significant was this feature in predicting the projected revenue of the property in the specified time horizon). In some embodiments, the list may relate to a predetermined number of features that had the greatest impact on the prediction made by the model, for example based on the ranking explained above.

In some embodiments, reporting module 130 is configured to receive a request for a report on a specific property portfolio, for example via user interface 114. In response to the request, the reporting module 130 is configured to generate a portfolio report for the specified property portfolio.

For example, the report may include the likelihood that a certain percentage of the properties in the portfolio will remain occupied for one or more time horizons. As another example, the report may include a list of one or more risk factors that may substantially decrease the revenue gained from the portfolio. As yet a further example, the report may include a breakdown (e.g., in percentages) of the types of tenants occupying the properties in the portfolio. The portfolio report may include, for each such parameter, a list of features relating to that parameter, and information relating to those features. For example, the list of features may be similar to that described hereinabove with respect to the property reports of any one or more of the models.

In some embodiments, the report, e.g., a property report or a portfolio report, may be provided to the user electronically, for example displayed on a screen forming output interface 115, or sent to the user as an email. In some embodiments, the report may be printed, to be provided to the user physically.

In some embodiments, storage medium 112 may further have stored a real-estate module 132, configured, in response to receipt of a property report relating to a specific property, to automatically take an action relating to the property. For example, real-estate module 132 may automatically list the property for sale, renew a lease for the property, or provide an offer to buy the property. As another example, real-estate module 132 may automatically email a potential tenant with a suggestion for a meeting or a discussion of one or more properties.

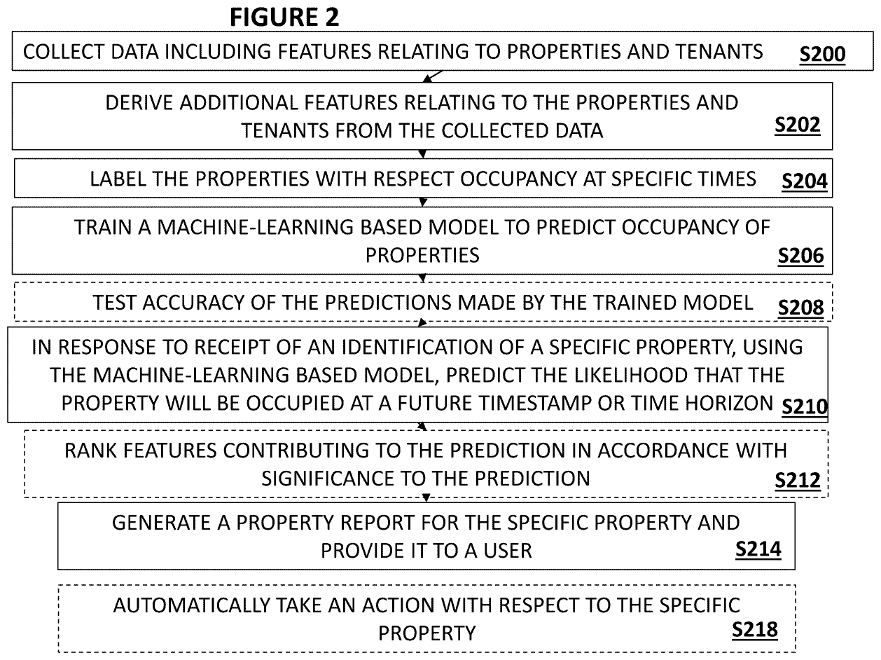

Reference is now made to FIG. 2, which is a flow chart of an embodiment of a method of predicting occupancy of a property leased to a tenant in accordance with an embodiment of the teachings herein, which may be implemented using the system of FIG. 1.

As seen in FIG. 2, at step S200, data is collected, typically from multiple sources, the data relating to properties, tenants, and/or to aspects that may impact leases of the properties by the tenants. For example, the data may relate to physical features of properties (e.g. square footage, accessibility, address, etc), occupation of the properties by tenants (e.g., occupied or vacant), sales data relating to the property (e.g., average number of transactions per month, average sum spent per transaction, etc), data relating to foot traffic in the property (e.g., how many shoppers per day, what is the trade area from which X % of the shoppers come, etc), demographic data relating to shoppers in the property (e.g., ethnicity in the trade area, average age of shoppers or of residents of the trade area, socio-economical standing of people in the trade area, etc), general economic data (e.g., GDP data, regional economic data, national economic data, global economic data, etc), and/or real-estate data (e.g., data about leases in the area, tenants in the area, etc). The collected data is typically stored, for example in a database.

In some embodiments, the collected data relates to a specific property. In some embodiments, the collected data relates to all properties leased to a specific tenant, or brand. In some embodiments, the collected data relates to multiple properties leased to multiple different tenants. In some embodiments, the collected data relates to all properties leased to major retain brands, or tenants, for example brands that are widely traded in the commercial real-estate market, regionally or nationally.

In some embodiments, the collected data may relate to features of the property or properties, at the time of data collection. In some embodiments, the collected data may include historical data, relating to various features of the property or properties, over a previous duration of predetermined length. For example, the data may relate to the last 3 years, the last 5 years, the last 7 years, or the last 10 years.

At step S202, additional features to the properties and/or tenants are derived, or computed, from the data collected at step S200. The derived features may also be stored in the database. In some embodiments, the derivation of the additional features may be carried out using machine learning techniques, such as neural networks.

Following collection and derivation of features relating to the properties, tenants, and various other aspects that may impact the leasing of the properties, a machine-learning-based model for predicting occupancy of a given property, or of a number of properties, is trained and tested, in multiple steps. In some embodiments, the model may be dedicated to a specific brand, or retailer (e.g., CVS). In some other embodiments, the model may be dedicated to a specific industry, and be suitable for various brands or retailers of that industry (e.g., pharmacies).

At step S204, labels are received, and applied, to at least some of the collected data, based on a known truth. Specifically, for at least one property for which data was collected, and typically for each such property, labels are received and applied to mark the property as occupied or vacant, at a specific timestamp or for a specific time window, for example via a user interface. In some embodiments, the labeled may be received from 3^{rd} party data providers, for example ones drawing the information from lists of locations on company websites. For example, the property may be labeled as being occupied or vacant on January 1^{st} of a specific year, or on January 1^{st} of each of a plurality of years. As another example, the property may be labeled as having been consistently occupied, or consistently vacant, for a given prior time window, such as the last 3 years, the last 5 years, or the last 7 years. In some embodiments, time window labeling may be provided directly by the user, or may be computed based on the user's labeling of the property as being occupied or vacant at specific dates.

In some embodiments, the applied labels are stored in the database, for example as additional features for each of the classified properties.

At step S206, the machine-learning-based model is trained using a first portion of the labeled data, together with the collected and derived features relating to each property. Training of the model typically uses existing machine-learning algorithms, such as xgboost, random forest, neural networks, and the like. Once trained, the model is expected to predict the probability of a property being vacant or occupied, at a specific future timestamp or for a predetermined future time window (e.g. for the next 3 or 5 years).

The model is then tested at step S208, using a second portion of the data, not used for training the model, to ensure that the predictions made by the model with respect to that data are congruent with the known labels of the data. Naturally, when testing the accuracy of predictions made by the model, the labels for the second portion of the data are not provided to the model, and are only used for comparison to the predictions made by the model.

Following completion of step S208, the model is trained, tested, and ready for use.

At some later time, at step S210 receives provided recent data, and is used to predict the likelihood of a specific property being occupied at a specific future time, or for a given time horizon, based on the received data and previous training.

In some embodiments, the model provides a prediction which includes a likelihood, or weight, that the property will be leased to a specific tenant, or to any tenant, for one or more time horizons.

In some embodiments, the model may provide predictions including a likelihood of occupancy for all properties currently occupied by a specific tenant, for one or more time horizons.

At step S212, at least some of the features used by the model in making the prediction, and in some embodiments all of the features used by the model, may be ranked according to their importance in determining the predicted occupancy of a property for a time horizon. In some embodiments, the ranking may be model-based—i.e., may be common to all predictions made by the model, whether for a specific brand or for a specific industry. In other embodiments, the ranking may be property-based—i.e., may be a unique ranking showing the effect of the features on the classification of each specific property for a given time horizon. In some embodiments, existing algorithms, such as SHAPs, may be used to provide this feature ranking. In some embodiments, the ranking may be carried out by a ranking module, for example stored in storage medium 112.

At step S214, a property report is generated for a specific property, or for a plurality of properties (e.g. all properties leased to a specific tenant), based on the predictions of the model, and is provided to a user. In some embodiments, the property report is generated in response to receipt of a specific request for a prediction of a specific property, with respect to one or more time horizons.

In some embodiments, the property report may include a chart or other data structure showing the likelihood of the property remaining occupied over multiple time horizons.

In some embodiments, the property report may include a list of features relating to the property and information relating to those features. For example, for each listed feature, the information may include the value of the property for that feature, a comparative value of another property for that feature, a ranking of whether the feature contributes to a positive or negative outcome in the long-run (e.g. when the feature increases the likelihood of the property remaining occupied that is considered contribution to a positive outcome), and/or a ranking of the significance of the feature in reaching the provided prediction (e.g., how significant was this feature in predicting the occupancy or vacancy of the property in the specified time horizon). In some embodiments, the list may relate to a predetermined number of features that had the greatest impact on the prediction made by the model, for example based on the ranking explained above.

In some embodiments, the property report may further include a comparison to another property, such as a comparison to the main neighbor, main competitor, or to an average property of the same brand.

The generated report may be provided to a user, for example via an output interface (e.g., displayed on a screen or printed on paper by a printer) or by email or another form of electronic message sent to the user via a network interface.

In some embodiments, in response to a prediction made by the model with respect to a specific property, or in response to receipt of a property report relating to that specific property, at step S218 an action relating to the property may be automatically taken. For example, the property may be automatically listed for sale, a lease for the property may be automatically renewed, or an offer to buy the property may be automatically provided.

In some embodiments, data collection at step S200 and/or feature generation at step S202 may be periodically or intermittently updated, for example once a month.

Reference is now made to FIG. 3, which is a flow chart of a method of suitable re-tenanting operations for a property in accordance with an embodiment of the teachings herein, which may be implemented using the system of FIG. 1.

As seen in FIG. 2, at step S220, data is collected, typically from multiple sources, the data relating to properties, tenants, and/or to aspects that may impact leases of the properties by the tenants. For example, the data may be similar to data collected in step S200 of FIG. 2, as described hereinabove. As another example, the collected data may relate to potential tenant and their properties, such as the industry of the tenant, the physical features of properties rented by the potential tenant (e.g. square footage, accessibility, address, etc), sales data relating to properties rented by the potential tenant (e.g., average number of transactions per month, average sum spent per transaction, etc), data relating to foot traffic in properties rented by the potential tenant (e.g., how many shoppers per day, what is the trade area from which X % of the shoppers come, etc), demographic data relating to shoppers in properties rented by the potential tenant (e.g., ethnicity in the trade area, average age of shoppers or of residents of the trade area, socio-economical standing of people in the trade area, etc), and/or occupancy of properties rented by the potential tenant (e.g., times at which the potential tenant occupied/vacated properties, length of occupancy or lease, etc.) The collected data is typically stored, for example in a database.

In some embodiments, the collected data may relate to features of the property and/or of a potential tenant, at the time of data collection. In some embodiments, the collected data may include historical data, relating to various features of the property or properties or of the potential tenant, over a previous duration of predetermined length. For example, the data may relate to the last 3 years, the last 5 years, the last 7 years, or the last 10 years.

At step S222, additional features to the properties and/or tenants are derived, or computed, from the data collected at step S220. The derived features may also be stored in the database. In some embodiments, the derivation of the additional features may be carried out using machine learning techniques, such as neural networks.

For example, the additional features of a potential tenant may include the likelihood of a potential tenant to occupy another property in an area that they already have a property, which would “cannibalize” some of the foot traffic or profit of the existing occupied property. As another example, the additional features of a potential tenant may include the likelihood of the potential tenant to replace a property that they already rent with a specified property being assessed by the re-tenanting model.

Following collection and derivation of features relating to the properties, tenants, and various other aspects that may impact the leasing of the properties, a machine-learning-based model for predicting occupancy of a given property, or of a number of properties, is trained and tested, in multiple steps.

At step S224, for each potential tenant, a list of properties currently occupied by the potential tenant is generated. A subset of the properties currently occupied by the potential tenant that are the best ranking properties for that potential tenant are identified and labeled as such. For example, in some embodiments, the best ranking properties are ranked using the occupancy predicting model described hereinabove.

At step S226, a profile of each of the labeled properties is extracted. In some embodiments, the profile may be extracted at least in part from a machine learning model. In some embodiments, the profile may be extracted by querying the database with respect to features (collected or derived) of each labeled property.

At step S228, the property to be re-tenanted is compared to the “best properties” for each specific potential tenant, and is ranked with respect to the ideal for that tenant. Typically, a prediction is made as to the likelihood of the potential tenant to occupy the property.

In some embodiments, the ranking of the property to be re-tenanted is carried out using machine learning techniques. In some such embodiments, a machine-learning-based model is trained using information about the properties labeled as being “best” for the specific tenant, using the collected and derived features relating to each such property and to the potential tenant. Training of the model typically uses existing machine-learning algorithms, such as xgboost, random forest, neural networks, and the like. Once trained, the model is expected to predict the probability of the potential tenant wanting to occupy a property. The prediction may be a general prediction, or may relate to a specific future timestamp or for a predetermined future time window (e.g. for the next 3 or 5 years).

The model can then be used to predict the likelihood that the potential tenant will be interested in occupying the property to be re-tenanted, or a portion of that property, if it were to be subdivided.

In some embodiments, the model provides a prediction which includes a likelihood, or weight, that the property will be leased to the potential tenant, or to any tenant, for one or more time horizons. In some embodiments, the model may provide a potential revenue or lease value or rate if the property is leased to the potential tenant.

At step S230, at least some of the features used by the model in making the prediction, and in some embodiments all of the features used by the model, may be ranked according to their importance in determining whether the potential tenant would be interested in re-tenanting the property.

At step S232, a property report is generated for a specific potential tenant, or for a plurality of potential tenants, with respect to the property to be re-tenanted (e.g. all properties leased to a specific tenant), based on the predictions of the model, and is provided to a user.

In some embodiments, the property report may include list of one or more potential tenants, a match score for those clients, a projection of rent that can be received per square foot, and/or contact information for contacting the potential tenant. Under the assumption that the property may be subdivided, the property report may include a similar list, or similar information, for each portion of the subdivided property.

In some embodiments in which the property may be subdivided, the property report may include an optimal combination recommendation, listing an optimized combination of tenants for each portion of the subdivided property.

In some embodiments, the property report may include a chart or other data structure showing the factors contributing to the match score of one or more of the listed potential tenants.

In some embodiments, the property report may further include a recommendation whether the property should be leased as is, or subdivided, the recommendation taking into account the cost of subdivision and the combination value.

The generated report may be provided to a user, for example via an output interface (e.g., displayed on a screen or printed on paper by a printer) or by email or another form of electronic message sent to the user via a network interface.

In some embodiments, in response to a prediction made by the model with respect to a specific property, or in response to receipt of a report relating to a specific potential tenant for a property, at step S234 an action relating to the property and/or the potential tenant may be automatically taken. For example, a communication may be sent to the potential tenant to offer discussion of leasing of the property.

A revenue projection model in accordance with the disclosed technology could be implemented using a method substantially similar to that described hereinabove with respect to occupancy prediction, and to FIG. 2. However, when implementing a revenue projection model, at step S204, the labels of the properties would reflect rental amounts, either per property or per square foot, rather than occupancy at a specific time. Additionally, the model would be trained to predict a probability distribution over rental amounts, rather than a probability of closure.

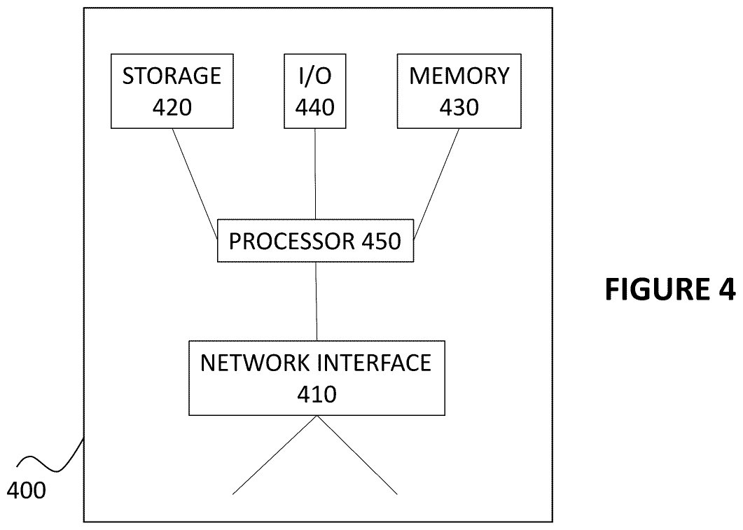

For example, a property report output by the model may include probabilities for receiving different rental amounts, for example per square foot. For example, the output may list a 30% probability of the rent per square foot being in the range of $8-$10, a probability of 50% probability of the rent per square foot being in the range of $10-$12, and a 20% probability of the rent per square foot being greater than $12. FIG. 4 shows a high level block diagram of a system 400, which may be used as system 100, to carry out embodiments of the disclosed technology. In some embodiments, the software modules described with respect to FIG. 1 may also be implemented in a system 400, for example as instructions to be implemented by a processor, stored in a storage device, as explained herein.

Device 400 comprises a processor 450 that controls the overall operation of the computerized device by executing the device's program instructions which define such operation. The device's program instructions may be stored in a storage device 420 (e.g., magnetic disk, database) and loaded into memory 430 when execution of the console's program instructions is desired. For example, the storage device 420 may store instructions for collecting a set of behavioral data during an online transaction. Thus, the device's operation will be defined by the device's program instructions stored in memory 430 and/or storage 420, and the console will be controlled by processor 450 executing the console's program instructions.

A device 400 also includes one or a plurality of input network interfaces for communicating with other devices via a network (e.g., the internet). The device 400 further includes an electrical input interface. A device 400 also includes one or more output network interfaces 410 for communicating with other devices. For example, the output network interfaces 410 may facilitate communication between device 400 and the central server.

Device 400 also includes input/output 440 representing devices which allow for user interaction with a computer (e.g., display, keyboard, mouse, speakers, buttons, etc.). Such input devices may be used when the user interacts with the computerized device during the online transaction, such that the data relating thereto can be collected by the processor.

One skilled in the art will recognize that an implementation of an actual device will contain other components as well, and that FIG. 4 is a high-level representation of some of the components of such a device for illustrative purposes. It should also be understood by one skilled in the art that the method and devices depicted in FIGS. 1-3 may be implemented on a device such as is shown in FIG. 4.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A computer implemented method for predictive modeling, the method including:
(a) collecting, from a plurality of sources, data relating to properties leased to tenants, the data including features relating to at least one of the properties, the tenants, a region in which the properties are located, national data, and global data;
(b) deriving, from the collected data, additional features relating to at least one of the properties and the tenants;
(c) for each of said properties of said tenants, receiving a label indicating a characteristic of the property or the tenant, to generate a collection including a plurality of labeled properties or tenants, each associated with a plurality of property-features or tenant-features;
(d) training a machine-learning based model to predict a parameter a specific property or of a specific tenant, by providing to the machine-learning based model a first subset of the collection, including a first subset of the plurality of labeled properties and their associated property-features and/or a first subset of the plurality of labeled tenants and their associated tenant features;
(e) following said training, in response to receipt of an indication of a specific property or tenant, obtaining from the machine-learning based model a prediction of the parameter for the property or the tenant; and
(f) generating a report including at least the prediction made by the machine-learning based model.

2. The computer implemented method of claim 1, wherein:
at step (c), the receiving of the label comprises receiving a label indicating occupancy or vacancy of the property at one or more specific past times, and the collection comprises a collection of labeled properties, each associated with a plurality of property-features;
at step (d), the training comprises training the machine-learning based model to predict occupancy or vacancy of a specific property; and
at step (e), the obtaining comprises, obtaining from the machine-learning based model a prediction including a probability that the specific property will remain occupied for one or more predetermined time horizons.

3. The computer implemented method of claim 1, wherein:
at step (c), the receiving of the label comprises receiving a label indicating, for a specific potential tenant, a quality of properties rented by the specific potential tenant or a rental amount paid by the specific potential tenant for another property;
at step (d), the training comprises training the machine-learning based model to predict a likelihood that the specific potential tenant would want to occupy a specific property; and
at step (e), the obtaining comprises, obtaining from the machine-learning based model a prediction including a probability that the specific potential tenant would occupy the specific property.

4. The computer implemented method of claim 1, wherein:
at step (c), the receiving of the label comprises receiving a label indicating a rental amount paid for the property currently or at one or more specific past times, and the collection comprises a collection of labeled properties, each associated with a plurality of property-features;
at step (d), the training comprises training the machine-learning based model to predict a distribution of a rental amounts expected to be paid for a specific property; and
at step (e), the obtaining comprises, obtaining from the machine-learning based model a prediction including a probability distribution of a rental amount that will be paid for the specific property at one or more predetermined future timestamps.

5. The computer implemented method of claim 1, further comprising, following (d) and prior to (e), testing accuracy of the machine-learning based model by providing to the machine-learning based model a second subset of the collection, including a second subset of the properties and their associated property-features, without providing the labels associated with the second subset of the properties to the machine-learning based model, and comparing predictions made by the machine-learning based model to the labels associated with the second subset of the properties.

6. The computer implemented method of claim 1, further comprising, following (e) and prior to (f), ranking features in accordance with their contribution to the prediction made by the machine-learning based model.

7. The computer implemented method of claim 6, wherein the providing of the report comprises providing a report including at least a subset of the ranked features.

8. The computer implemented method of claim 1, further comprising, following (e), automatically taking an action with respect to the specific property or tenant.

9. A computer implemented method of assessing a risk of a property portfolio of a property owner, the property portfolio including a plurality of properties, the method comprising:
(a) for each property of the plurality of properties, carrying out the method of claim 1 to predict at least one parameter relating to the property; and
(b) providing to the property owner a portfolio report, based on the report generated for each property, the portfolio report indicating at least one of:
a risk factor expected to impact a subset of the plurality of properties greater than a threshold subset size;
a percentage or number of the plurality of properties at risk by a specific risk factor;
a percentage or sum of revenue eat risk by the specific risk factor;
one or more suggestions for diversification of the portfolio; and
one or more suggestions for redevelopment or subdivision of one or more of the plurality of properties.

10. The computer implemented method of claim 9, wherein step (a) comprises, for each property of the plurality of properties, predicting a probability that the property will remain occupied for one or more predetermined time zones.

11. The computer implemented method of claim 9, wherein step (a) comprises, for each property of the plurality of properties, predicting a distribution probability of rental income that can be obtained from the property currently or at one or more predetermined future time stamps.

12. The computer implemented method of claim 9, wherein step (a) comprises, for each property of the plurality of properties, predicting whether redevelopment or subdivision of the property would increase the revenue gained from the property, currently or at one or more predetermined future time stamps.

13. The computer implemented method of claim 9, wherein step (a) comprises, for each property of the plurality of properties, proposing one or more potential tenants predicted to have an interest in renting the property, currently or at one or more predetermined future time stamps.

14. The computer implemented method of claim 9, further comprising repeating steps (a) and (b) periodically.
